(19) United States
(12) Patent Application Publication
(10) Pub. No.: US 2024/0021889 A1
(43) Pub. Date: Jan. 18, 2024

(54) COMPOSITION

(71) Applicant: Mexichem Fluor S.A. de C.V., San Luis Potosi (MX)

(72) Inventors: Andrew SHARRATT, Runcorn (GB); Miodrag OLJACA, Concord, MA (US)

(21) Appl. No.: 18/256,253

(22) PCT Filed: Dec. 9, 2021
(86) PCT No.: PCT/GB2021/053226

§ 371 Date: Jun. 7, 2023

Related U.S. Application Data
(60) Provisional application No. 63/124,391, filed on Dec. 11, 2020.

(30) Foreign Application Priority Data
Feb. 17, 2021 (GB) 2102234.8

(51) Int. Cl. H01M 10/42; H01M 10/0569; H01M 10/0567

(52) U.S. Cl. CPC H01M 10/4235; H01M 10/0569; H01M 10/0567; H01M 2300/0037

(57) ABSTRACT

Use of a compound of Formula 1 in a nonaqueous battery electrolyte formulation (1) wherein R is a fluorinated alkyl group and X is selected from the group consisting of F, Cl, H, CF₃, and C₁ to C₆ alkyl which may be at least partially fluorinated and —OR group can be cis- or trans- to any other group X.

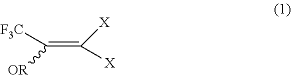

### COMPOSITION

The present disclosure relates to nonaqueous electrolytic solutions for energy storage devices including batteries and capacitors, especially for secondary batteries and devices known as supercapacitiors.

There are two main types of batteries; primary and secondary. Primary batteries are also known as non-rechargeable batteries. Secondary batteries are also known as rechargeable batteries. A well-known type of rechargeable battery is the lithium-ion battery. Lithium-ion batteries have a high energy density, no memory effect and low self-discharge.

Lithium-ion batteries are commonly used for portable electronics and electric vehicles. In the batteries, lithium ions move from the negative electrode to the positive electrode during discharge, and back when charging.

Typically, the electrolytic solutions include a nonaqueous solvent and an electrolyte salt, plus additives. The electrolyte is typically a mixture of organic carbonates such as ethylene carbonate, propylene carbonate, fluoroethylene carbonate and dialkyl carbonates containing a lithium ion electrolyte salt. Many lithium salts can be used as the electrolyte salt, and common examples include lithium hexafluorophosphate (LiPF₆), lithium bis (fluorosulfonyl) imide “LiFSI” and lithium bis(trifluoromethanesulfonyl)imide (LiTFSI).

The electrolytic solution has to perform a number of separate roles within the battery.

The principal role of the electrolyte is to facilitate the flow of electrical charge between the cathode and anode. This occurs by transportation of metal ions within the battery from and or to one or both of the anode and cathode, where by chemical reduction or oxidation, electrical charge is liberated/adopted.

Thus, the electrolyte needs to provide a medium which is capable of solvating and/or supporting the metal ions.

Due to the use of lithium electrolyte salts and the interchange of lithium ions with lithium metal, which is very reactive with water, as well as the sensitivity of other battery components to water, the electrolyte is usually non-aqueous.

Additionally, the electrolyte has to have suitable rheological properties to permit/enhance the flow of ions therein, at the typical operating temperature to which a battery is exposed and expected to perform.

Moreover the electrolyte has to be as chemically inert as possible. This is particularly relevant, in the context of the expected lifetime of the battery, with regard to internal corrosion within the battery (e.g. of the electrodes and casing) and the issue of battery leakage. Also of importance within the consideration of chemical stability is flammability. Unfortunately typical electrolyte solvents can be a safety hazard, since they often comprise a flammable material.

This can be problematic as in operation when discharging or being discharged, batteries may accumulate heat. This is especially true for high density batteries such as lithium ion batteries. It is therefore desirable that the electrolyte displays a low flammability, with other related properties such as a high flash point.

It is also desirable that the electrolyte does not present an environmental issue with regard to disposability after use or other environmental issue such as global warming potential.

It is an object of the present invention to provide a nonaqueous electrolytic solution, which provides improved properties over the nonaqueous electrolytic solution of the prior art.

Use Aspects

According to a first aspect of the invention there is provided the use of a compound of Formula 1 in a nonaqueous battery electrolyte formulation. Preferably the composition comprising a compound of Formula 1 is used in a lithium ion battery.

According to a second aspect of the invention there is provided the use of a nonaqueous battery electrolyte formulation comprising a compound of Formula 1 in a battery.

Composition/Device Aspects

According to a third aspect of the invention there is provided a battery electrolyte formulation comprising a compound of Formula 1.

According to a fourth aspect of the invention there is provided a formulation comprising a metal ion and a compound of Formula 1, optionally in combination with a solvent.

According to a fifth aspect of the invention there is provided a battery comprising a battery electrolyte formulation comprising a compound of Formula 1.

Method Aspects

According to a sixth aspect of the invention there is provided a method of reducing the flash point of a battery and/or a battery electrolyte formulation, comprising the addition of a formulation comprising a compound of Formula 1.

According to a seventh aspect of the invention there is provided a method of powering an article comprising the use of a battery comprising a battery electrolyte formulation comprising a compound of Formula 1.

According to an eighth aspect of the invention there is provided a method of retrofitting a battery electrolyte formulation comprising either (a) at least partial replacement of the battery electrolyte with a battery electrolyte formulation comprising a compound of Formula 1, and/or (b) supplementation of the battery electrolyte with a battery electrolyte formulation comprising a compound of Formula 1.

According to a ninth aspect of the invention there is provided a method of preparing a compound of method of preparing a compound of a compound of Formula 1 by reacting a compound of Formula 2a and/or Formula 2b

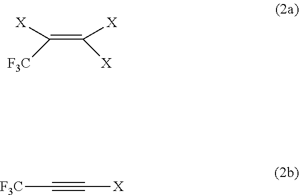

with an alcohol ROH in the presence of a strong base, optionally in the presence of a solvent, under suitable conditions of temperature and pressure. Conveniently, the solvent is a polar aprotic solvent; preferably it may be selected from N-methyl-2-pyrrolidone, acetonitrile, N,N-dimethylformamide, hexamethylphosphoramide, tetrahydrofuran or dimethyl sulfoxide. Conveniently, the strong base is an anhydrous or substantially anhydrous alkali metal hydroxide, alkoxide or hydride. Conveniently, the reaction is carried out at a temperature of 0° C. to 300° C. Conveniently, the reaction is carried out at a pressure of 0 to 100 bar.

In Formula 2a X is halogen or —CF₃ with the proviso that at least one X is H. Most preferably at least one X is halogen and at least one X is H and wherein where at least one X is halogen and one X is hydrogen these groups are trans to each other.

In Formula 2b X is hydrogen or —CF₃.

According to a tenth aspect of the invention there is provided a method of preparing a battery electrolyte formulation comprising mixing comprising a compound of Formula 1 with a lithium containing compound.

According to an eleventh aspect of the invention there is provided a method of improving battery capacity/charge transfer within a battery/battery life/etc. by the use of a compound of Formula 1.

Compound of Formula 1

In reference to all aspects of the invention the preferred embodiment of Formula (1) is below

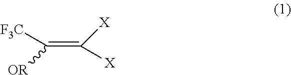

wherein

R is a fluorinated alkyl group and the stereochemistry of the —OR group can be either cis- or trans- to any other function, and X is selected from the group consisting of F, Cl, H, CF₃, and C₁ to C₆ alkyl which may be at least partially fluorinated.

Alternatively, and also in reference to all aspects of the invention an alternate embodiment of Formula (1) is below

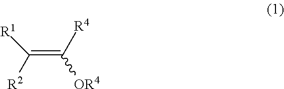

wherein
R¹ is selected from the group consisting of F, Cl, H, CF₃, and C₁ to C₆ alkyl which may be at least partially fluorinated;
R² is selected from the group consisting of F, Cl, H, CF₃, and C₁ to C₆ alkyl which may be at least partially fluorinated;
R³ is selected from the group consisting of F, Cl, H, CF₃, and C₁ to C₆ alkyl which may be at least partially fluorinated;
R⁴ is selected from the group consisting of and C₁ to C₁₂ alkyl which may be at least partially fluorinated;
wherein at least one of R¹ to R⁴ is or comprises F and the stereochemistry of the —OR⁴ group can be cis- or trans- to any other function.

It is to be noted that the ninth aspect of the invention shall be taken to apply to both embodiments of the Formula (1).

Advantages

In the aspects of the invention the electrolyte formulation has been found to be surprisingly advantageous.

The advantages of using compounds of Formula 1 in electrolyte solvent compositions manifest themselves in a number of ways. Their presence can reduce the flammability of the electrolyte composition (such as when for example measured by flashpoint). Their oxidative stability makes them useful for batteries required to work in harsh conditions and they are compatible with common electrode chemistries and can even enhance the performance of these electrodes through their interactions with them.

Additionally, electrolyte compositions comprising compounds of Formula 1 have been found to have superior physical properties including low viscosity and a low melting point, yet a high boiling point with the associated advantage of little or no gas generation in use. The electrolyte formulation has been found to wet and spread extremely well over surfaces, particularly fluorine-containing surfaces; this is postulated to result from a beneficial a relationship between its adhesive and cohesive forces, to yield a low contact angle.

Furthermore, electrolyte compositions that comprise compounds of Formula 1 have been found to have superior electro-chemical properties including improved capacity retention, improved cyclability and capacity, improved compatibility with other battery components e.g. separators and current collectors and with all types of cathode and anode chemistries including systems that operate across a range of voltages and especially high voltages and which include additives such as silicon. In addition, the electrolyte formulations display good solvation of metal (e.g. lithium) salts and interaction with any electrolyte solvents present.

Preferred features relating to the aspects of the invention follows below.

Preferred Compounds

Preferred examples of compounds of the first embodiment of Formula 1

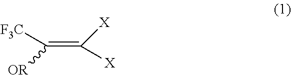

are where:—
R is CH₂CF₃, CH₂CF₂CF₂CHF₂ or CH(CF₃)₂; and
X is H.

Preferred features of the alternate embodiment of the compound of Formula 1

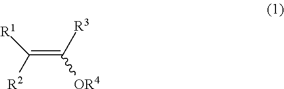

are as in the following numbered paragraphs.

Paragraph 1—the compound of Formula 1, wherein preferably at least two or three of R¹ to R⁴ is or comprises F; for example one or two of R¹ to R³ is or comprises F while R⁴ comprises F.

Paragraph 2—the compound of paragraph 1, wherein preferably only one of R¹ to R⁴ comprises C₁ to C₆ alkyl, whether unfluorinated or at least partially fluorinated.

Paragraph 3—the compound of paragraph 1 or 2, wherein preferably R² is selected from the group consisting of H, CF₃, and C₁ to C₆ alkyl which may be at least partially fluorinated.

Paragraph 4—the compound of paragraphs 1 to 3, wherein preferably R² is selected from the group consisting of H and CF₃.

Paragraph 5—the compound of paragraphs 1 to 4, wherein preferably R² is CF₃.

Paragraph 6—the compound of paragraphs 1 to 5, wherein preferably R⁴ is C₁ to C₆ alkyl which may be at least partially fluorinated; Paragraph 7—the compound of paragraphs 1 to 6, wherein preferably R⁴ is C₁ to C₄ alkyl which may be at least partially fluorinated; Paragraph 8—the compound of paragraphs 1 to 7, wherein preferably R⁴ is selected from the group consisting of ethyl, n-propyl, iso-propyl, n-butyl, iso-butyl and at least partially fluorinated derivatives thereof.

Paragraph 9—the compound of paragraphs 1 to 8, wherein preferably R⁴ is selected from the group consisting of CH₂CF₃, CH₂CH₂CF₃, CH₂CHFCF₃, CH₂CF₂CF₂CHF₂ and CH(CF₃)₂.

Paragraph 10—the compound of paragraphs 1 to 9, wherein preferably R¹ and R³ are independently selected from the group consisting of H, CF₃, and C₁ to C₆ alkyl which may be at least partially fluorinated.

Paragraph 11—the compound of paragraphs 1 to 10, wherein preferably R¹ and R³ are independently selected from the group consisting of H, CF₃, CH₂CF₃, CH₂CH₂CF₃, CH₂CHFCF₃, CH₂CF₂CF₂CHF₂ and CH(CF₃)₂.

Paragraph 12—the compound of paragraphs 1 to 11, wherein preferably R¹ and R³ are independently selected from the group consisting of H and CF₃.

Paragraph 13—the compound of paragraphs 1 to 12, wherein preferably R¹ and R³ is H.

Preferred examples of compounds of the alternate embodiment of the compound of Formula 1 are where:—
R¹ is H,
R² is CF₃,
R³ is H, and
R⁴ is CH₂CF₃, CH₂CF₂CF₂CHF₂ or CH(CF₃)₂.

Electrolyte Formulation

Preferably the electrolyte formulation comprises 0.1 wt % to 99.9 wt % of a compound of Formula 1. Optionally the compound of Formula 1 is present (in the electrolyte formulation) in an amount of more than 1 wt %, optionally more than 5 wt %, optionally more than 10 wt %, optionally more than 15 wt %, optionally more than 20 wt % and optionally more than 25 wt %. Optionally the compound of Formula 1 is present (in the electrolyte formulation) in an amount of less than 1 wt %, optionally less than 5 wt %, optionally less than 10 wt %, optionally less than 15 wt %, optionally less than 20 wt % and optionally less than 25 wt %.

Metal Salts

The nonaqueous electrolytic solution further comprises a metal electrolyte salt, typically present in an amount of 0.1 to 20 wt % relative to the total mass of the nonaqueous electrolyte formulation.

The metal salt generally comprises a salt of lithium, sodium, magnesium, calcium, lead, zinc or nickel.

Preferably the metal salt comprises a salt of lithium, such as those selected from the group comprising lithium hexafluorophosphate (LiPF₆), lithium hexafluoroarsenate monohydrate (LiAsF₆), lithium perchlorate (LiCIO₄), lithium tetrafluoroborate (LiBF₄), lithium triflate (LiSO₃CF₃), lithium bis(fluorosulfonyl)imide (Li(FSO₂)₂N) and lithium bis(trifluoromethanesulfonyl)imide (Li(CF₃SO₂)₂N).

Most preferably the metal salt comprises LiPF₆. Thus in a most preferred variant of the fourth aspect of the invention there is provided a formulation comprising LiPF₆ and a compound of Formula 1, optionally in combination with a solvent

Solvents

The nonaqueous electrolytic solution may comprise a solvent. Preferred examples of solvents include fluoroethylene carbonate (FEC) and/or propylene carbonate (PC), dimethyl carbonate (DMC), ethylmethyl carbonate (EMC) or ethylene carbonate (EC).

Where present, the solvent makes up from 0.1 wt % to 99.9 wt % of the liquid component of the electrolyte.

Additives

The nonaqueous electrolytic solution may include an additive.

Suitable additives may serve as surface film-forming agents, which form an ion permeable film on the surface of the positive electrode or the negative electrode. This can pre-empt a decomposition reaction of the nonaqueous electrolytic solution and the electrolyte salt occurring on the surface of the electrodes, thereby preventing the decomposition reaction of the nonaqueous electrolytic solution on the surface of the electrodes.

Examples of film-forming agent additives include vinylene carbonate (VC), ethylene sulfite (ES), lithium bis(oxalato)borate (LiBOB), cyclohexylbenzene (CHB) and ortho-terphenyl (OTP). The additives may be used singly, or two or more may be used in combination.

When present the additive is present in an amount of 0.1 to 3 wt % relative to the total mass of the nonaqueous electrolyte formulation.

Battery

Primary/Secondary Battery

The battery may comprise a primary (non-rechargeable) or a secondary battery (rechargeable). Most preferably the battery comprises a secondary battery.

A battery comprising the nonaqueous electrolytic solutions will generally comprise several elements. Elements making up the preferred nonaqueous electrolyte secondary battery cell are described below. It is appreciated that other battery elements may be present (such as a temperature sensor); the list of battery components below is not intended to be exhaustive.

Electrodes

The battery generally comprises a positive and negative electrode. Usually the electrodes are porous and permit metal ion (lithium ions) to move in and out of their structures with a process called insertion (intercalation) or extraction (deintercalation).

For rechargeable batteries (secondary batteries), the term cathode designates the electrode where reduction is taking place during the discharge cycle. For lithium-ion cells the positive electrode (“cathode”) is the lithium-based one.

Positive Electrode (Cathode)

The positive electrode is generally composed of a positive electrode current collector such as a metal foil, optionally with a positive electrode active material layer disposed on the positive electrode current collector.

The positive electrode current collector may be a foil of a metal that is stable at a range of potentials applied to the positive electrode, or a film having a skin layer of a metal that is stable at a range of potentials applied to the positive electrode. Aluminium (Al) is desirable as the metal that is stable at a range of potentials applied to the positive electrode.

The positive electrode active material layer generally includes a positive electrode active material and other components such as a conductive agent and a binder. This is generally obtained by mixing the components in a solvent, applying the mixture onto the positive electrode current collector, followed by drying and rolling.

The positive electrode active material may be a lithium (Li) containing transition metal oxide. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Some of the transition metal atoms in the transition metal oxide may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

Preferred examples of positive electrode active materials include lithium-containing transition metal oxides such as LiCoO₂, LiNiO₂, LiMn₂O₄, LiMnO₂, LiN_{1-y}Co_{y}O₂ (0<y<1), LiNi_{1-y-z}Co_{y}Mn_{z}O₂ (0<y+z<1) and LiNi_{1-y-z}Co_{y}Al_{z}O₂ (O<y+z<1). LiNi_{1-y-z}Co_{y}Mn_{z}O₂ (O<y+z<0.5) and LiNi_{1-y-z}Co_{y}Al_{z}O₂ (0<y+z<0.5) containing nickel in a proportion of not less than 50 mol % relative to all the transition metals are desirable from the perspective of cost and specific capacity. These positive electrode active materials contain a large amount of alkali components and thus accelerate the decomposition of nonaqueous electrolytic solutions to cause a decrease in durability. However, the nonaqueous electrolytic solution of the present disclosure is resistant to decomposition even when used in combination with these positive electrode active materials.

The positive electrode active material may be a lithium (Li) containing transition metal fluoride. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Some of the transition metal atoms in the transition metal fluoride may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

A conductive agent may be used to increase the electron conductivity of the positive electrode active material layer. Preferred examples of the conductive agents include conductive carbon materials, metal powders and organic materials. Specific examples include carbon materials as acetylene black, ketjen black and graphite, metal powders as aluminium powder, and organic materials as phenylene derivatives.

A binder may be used to ensure good contact between the positive electrode active material and the conductive agent, to increase the adhesion of the components such as the positive electrode active material with respect to the surface of the positive electrode current collector. Preferred examples of the binders include fluoropolymers and rubber polymers, such as polytetrafluoroethylene (PTFE), polyvinylidene fluoride (PVdF) ethylene-propylene-isoprene copolymer and ethylene-propylene-butadiene copolymer. The binder may be used in combination with a thickener such as carboxymethylcellulose (CMC) or polyethylene oxide (PEO).

Negative Electrode (Anode)

The negative electrode is generally composed of a negative electrode current collector such as a metal foil, optionally with a negative electrode active material layer disposed on the negative electrode current collector.

The negative electrode current collector may be a foil of a metal. Copper (lithium free) is suitable as the metal. Copper is easily processed at low cost and has good electron conductivity.

Generally, the negative electrode comprises carbon, such as graphite or graphene.

Silicon based materials can also be used for the negative electrode. A preferred form of silicon is in the form of nano-wires, which are preferably present on a support material. The support material may comprise a metal (such as steel) or a non-metal such as carbon.

The negative electrode may include an active material layer. Where present the active material layer includes a negative electrode active material and other components such as a binder. This is generally obtained by mixing the components in a solvent, applying the mixture onto the positive electrode current collector, followed by drying and rolling.

Negative electrode active materials are not particularly limited, provided the materials can store and release lithium ions. Examples of suitable negative electrode active materials include carbon materials, metals, alloys, metal oxides, metal nitrides, and lithium-intercalated carbon and silicon. Examples of carbon materials include natural/artificial graphite, and pitch-based carbon fibres. Preferred examples of metals include lithium (Li), silicon (Si), tin (Sn), germanium (Ge), indium (In), gallium (Ga), titanium, lithium alloys, silicon alloys and tin alloys. Examples of lithium based materials include lithium titanate (Li₂TiO₃)

As with the positive electrode, the binder may be a fluoropolymer or a rubber polymer and is desirably a rubbery polymer, such as styrene-butadiene copolymer (SBR). The binder may be used in combination with a thickener.

Separator

A separator is preferably present between the positive electrode and the negative electrode. The separator has insulating properties. The separator may comprise a porous film having ion permeability. Examples of porous films include microporous thin films, woven fabrics and nonwoven fabrics. Suitable materials for the separators are polyolefins, such as polyethylene and polypropylene.

Case

The battery components are preferably disposed within a protective case.

The case may comprise any suitable material which is resilient to provide support to the battery and an electrical contact to the device being powered.

In one embodiment the case comprises a metal material, preferably in sheet form, moulded into a battery shape. The metal material preferably comprises a number of portions adaptable be fitted together (e.g. by push-fitting) in the assembly of the battery. Preferably the case comprises an iron/steel-based material.

In another embodiment the case comprises a plastics material, moulded into a battery shape. The plastics material preferably comprises a number of portions adaptable be joined together (e.g. by push-fitting/adhesion) in the assembly of the battery. Preferably the case comprises a polymer such as polystyrene, polyethylene, polyvinyl chloride, polyvinylidene chloride, or polymonochlorofluoroethylene. The case may also comprise other additives for the plastics material, such as fillers or plasticisers. In this embodiment wherein the case for the battery predominantly comprises a plastics material a portion of the casing may additionally comprise a conductive/metallic material to establish electrical contact with the device being powered by the battery.

Arrangement

The positive electrode and negative electrode may be wound or stacked together through a separator. Together with the nonaqueous electrolytic solution they are accommodated in the exterior case. The positive and negative electrodes are electrically connected to the exterior case in separate portions thereof

Module/Pack

A number/plurality of battery cells may be made up into a battery module. In a battery module the battery cells may be organised in series and/or parallel. Typically these are encased in a mechanical structure.

A battery pack may be assembled by connecting multiple modules together in series or parallel. Typically battery packs include further features such as sensors and controllers including battery management systems and thermal management systems. The battery pack generally includes an encasing housing structure to make up the final battery pack product.

End Uses

The battery of the invention, in the form an individual battery/cell, module and/or pack (and the electrolyte formulations therefor) are intended to be used in one or more of a variety of end products.

Preferred examples of end products include portable electronic devices, such as GPS navigation devices, cameras, laptops, tablets and mobile phones. Other preferred examples of end products include vehicular devices (as provision of power for the propulsion system and/or for any electrical system or devices present therein) such as electrical bicycles and motorbikes as well as automotive applications (including hybrid and purely electric vehicles).

The invention will now be illustrated with reference to the following non-limiting examples.

### PREPARATIVE EXAMPLE

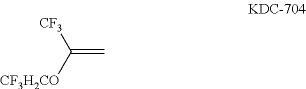

The compound designated KDC-704 was prepared using a procedure based on that reported in the Journal of Fluorine Chemistry, 179, p. 71-76 (2015):

According to this, sodium hydride (192 g 60%) was added to anhydrous dimethyl formamide (2.4 L). The resulting slurry was cooled and trifluoroethanol (219 g) was added to generate its alkoxide. This mixture was then transferred to autoclave and 2,3,3,3-tetrafluoropropene (224 g) added and the mixture stirred overnight. Unreacted 2,3,3,3-tetrafluoropropene was vented and contents were quenched with ice. The pH of the resulting mixture was adjusted to >6 whereupon the product separated as a lower layer. The product was recovered washed with water and then dried over MgSO₄ before distillation.

19F NMR (56 MHz): −74.44(s), −76.02(t).

Electrolyte Compositions Comprising KDC-704

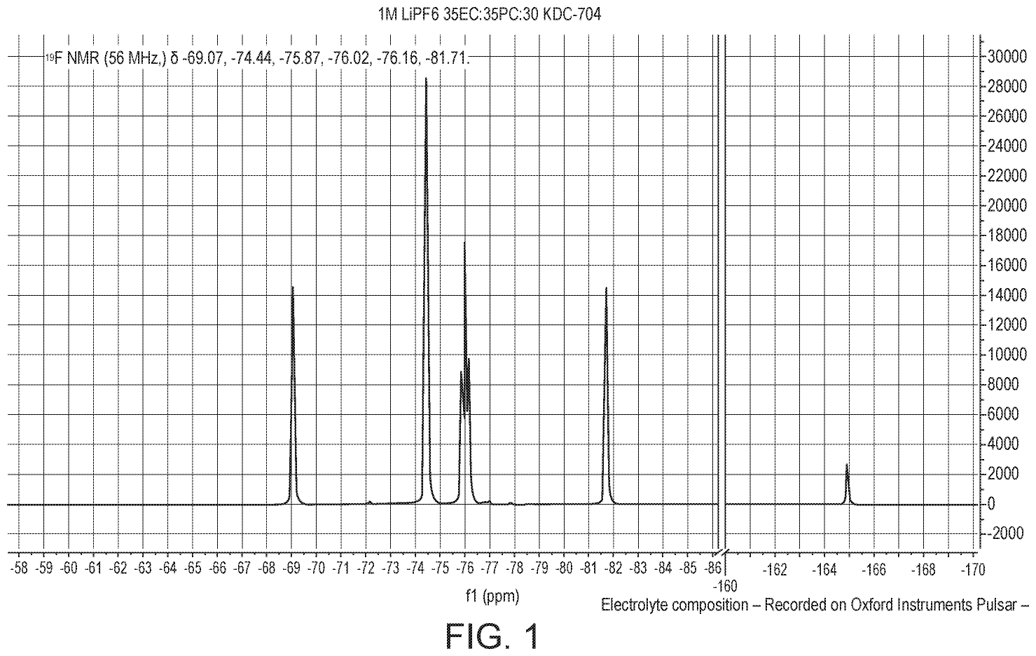

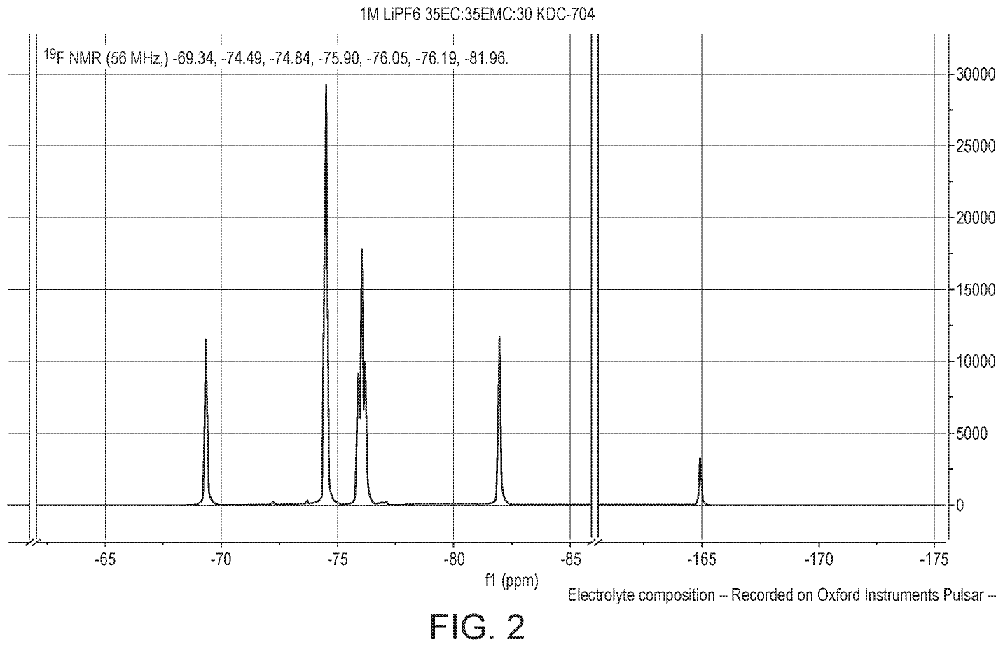

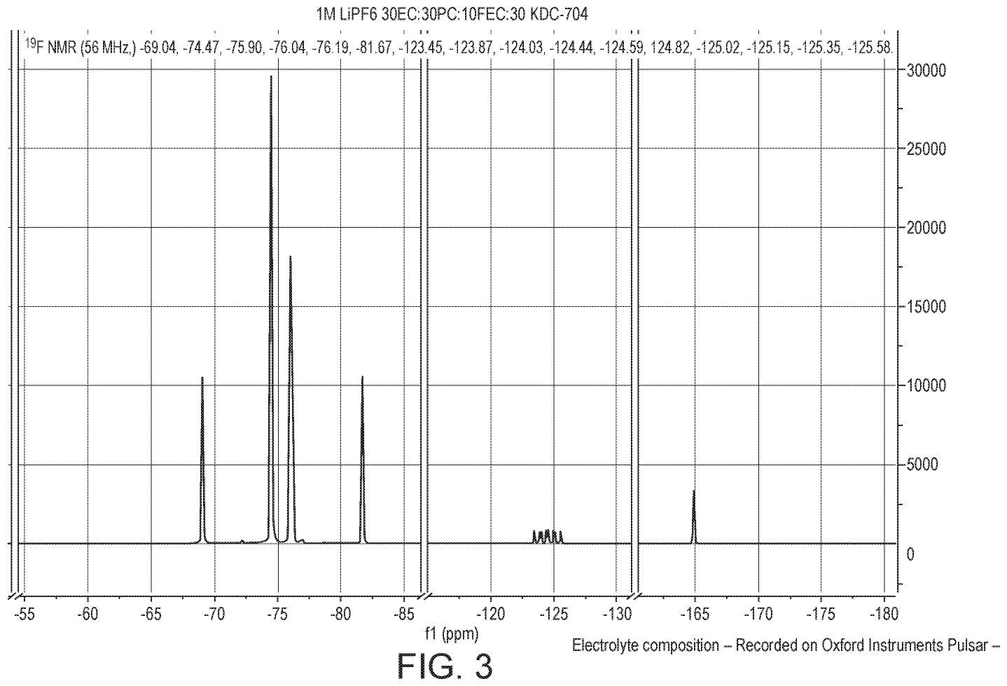

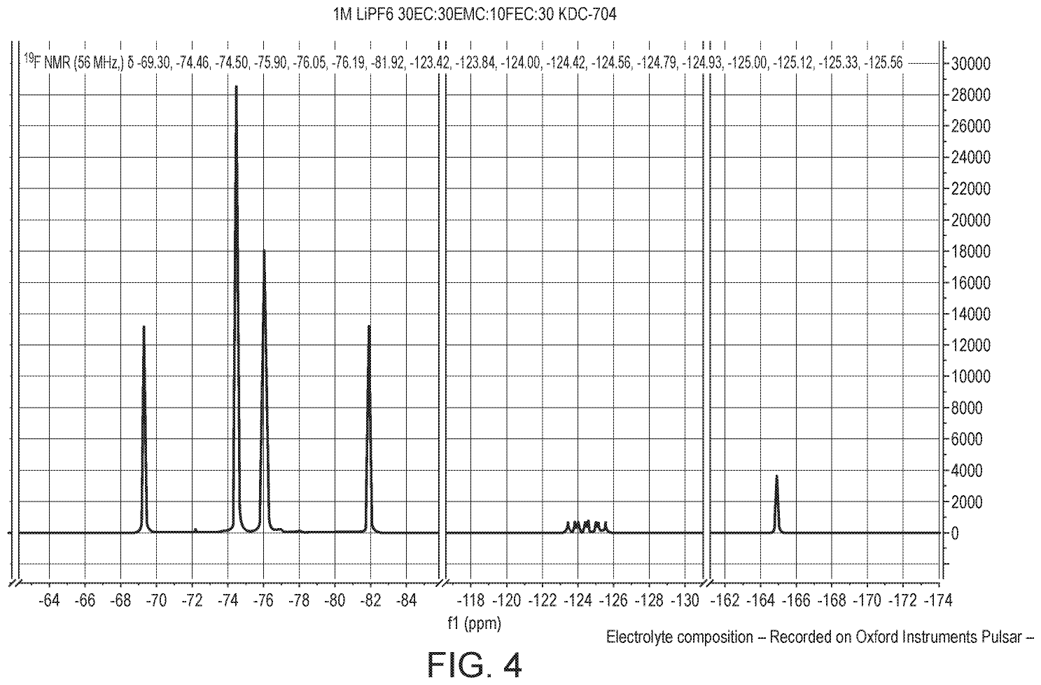

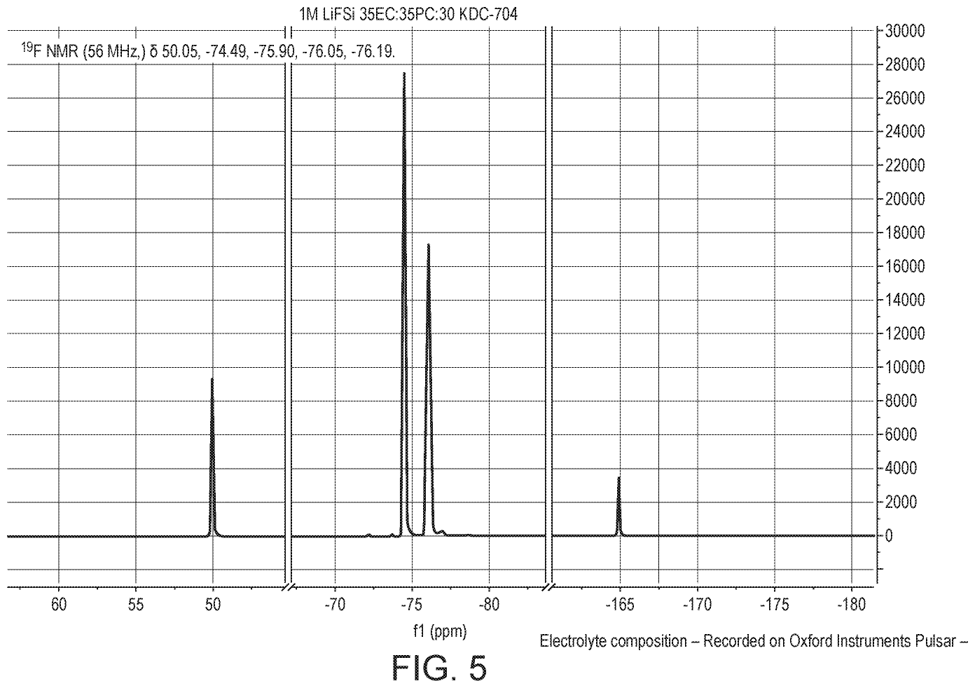

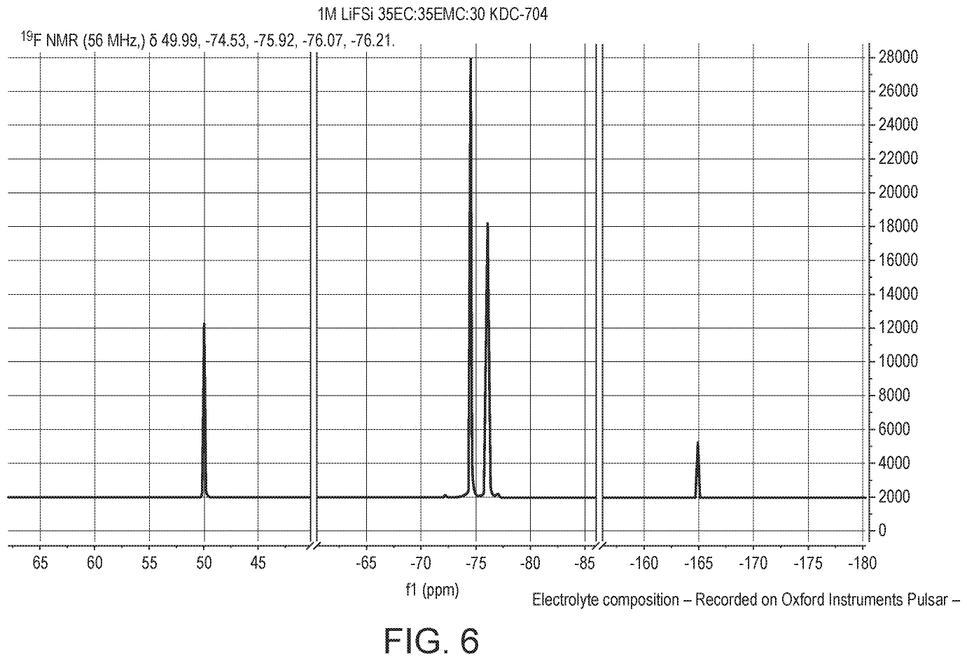

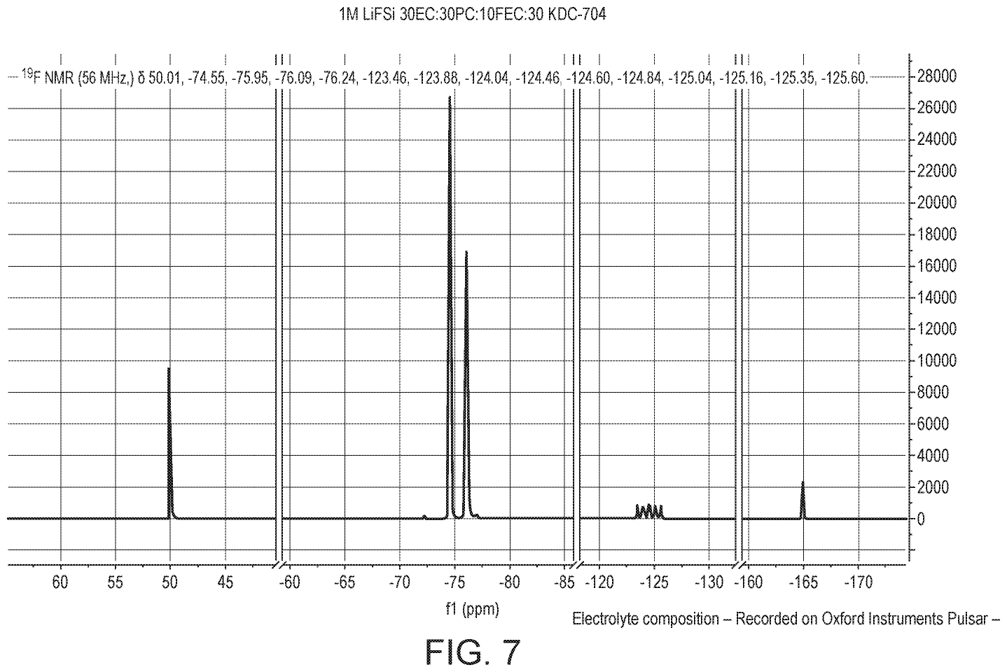

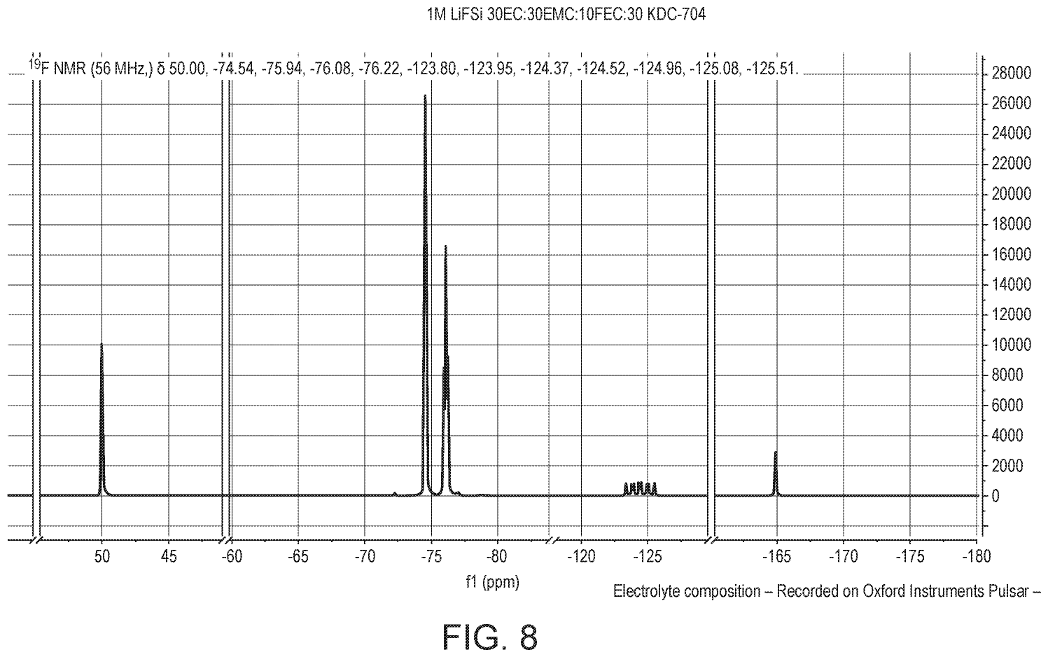

The following examples of electrolyte compositions comprising KDC-704 were prepared (all wt %):
1 M LiPF₆ 35EC:35PC:30 KDC-704 (see FIG. 1)
1 M LiPF₆ 35EC:35EMC:30 KDC-704 (see FIG. 2)
1 M LiPF₆ 30EC:30PC:10FEC:30 KDC-704 (see FIG. 3)
1 M LiPF₆ 30EC:30EMC:10FEC:30 KDC-704 (see FIG. 4)
1 M LiFSi 35EC:35PC:30 KDC-704 (see FIG. 5)
1 M LiFSi 35EC:35EMC:30 KDC-704 (see FIG. 6)
1 M LiFSi 30EC:30PC:10FEC:30 KDC-704 (see FIG. 7)
1 M LiFSi 30EC:30EMC:10FEC:30 KDC-704 (see FIG. 8)

Note:
EC=ethylene carbonate
PC=propylene carbonate
EMC=ethyl methyl carbonate
FEC=fluoroethylene carbonate
LiPF₆=lithium hexafluorophosphate
LiFSI=lithium bis(fluorosulfonyl) imide

The results are shown in FIGS. 1 to 8. These ¹⁹F NMR spectra indicate that the resultant electrolyte compositions are compatible and soluble.

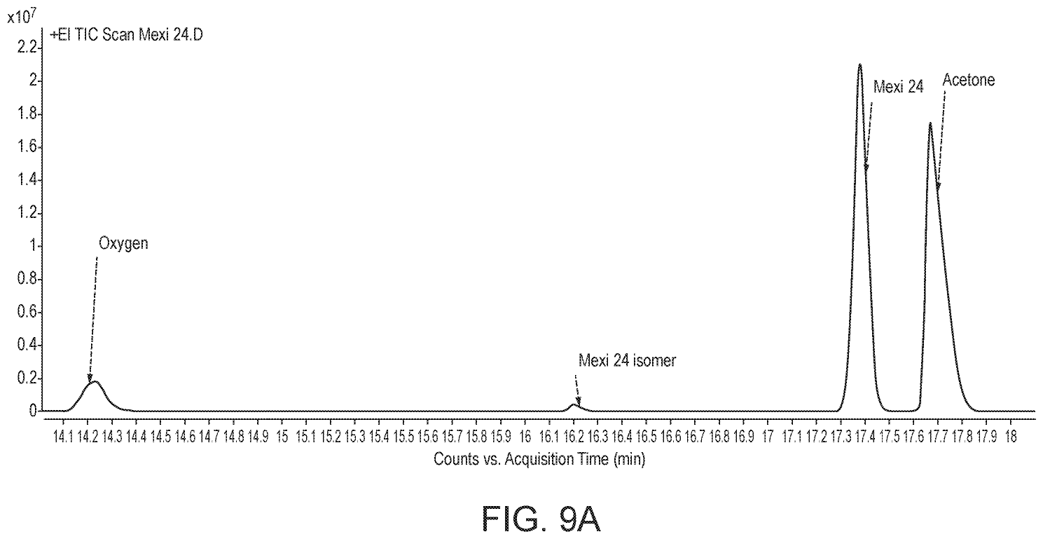

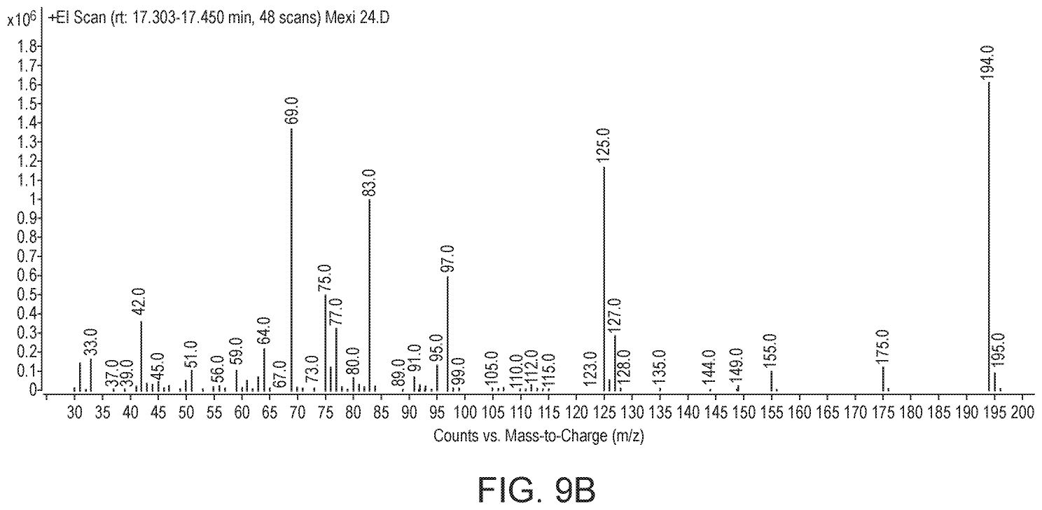

FIGS. 9a and 9b shows the Gas Chromatograph and Mass Spectral analysis of KDC-704.

Mass spectrum m/z: 194 ([M]+), 175 ([M-F]+), 125 ([M-CF₃]+), 97, 83 ([CF₃CH₂]+), 69 ([CF₃]+), 42.

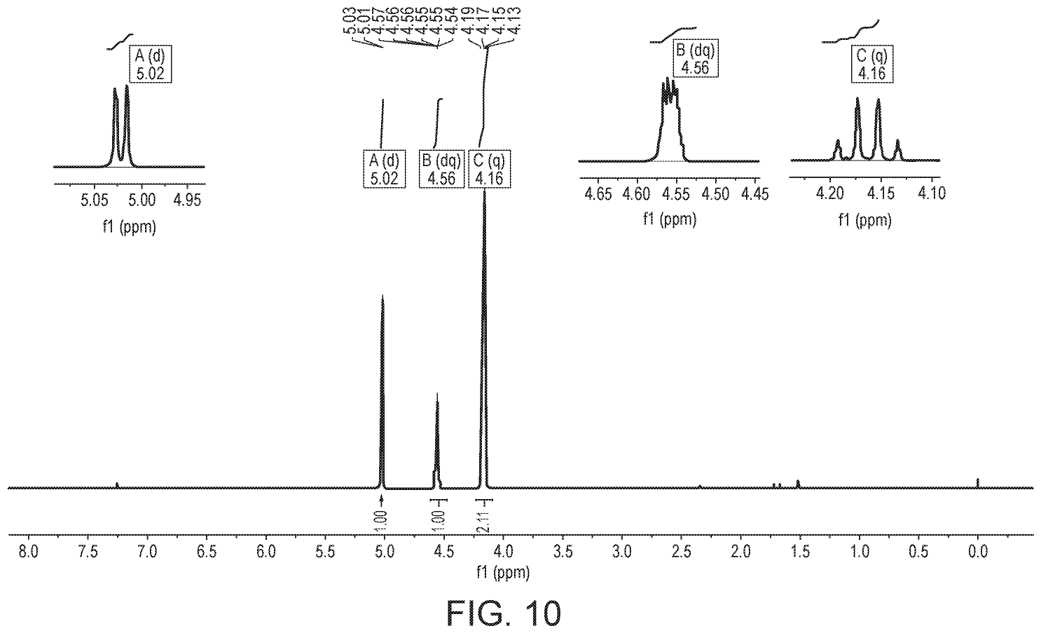

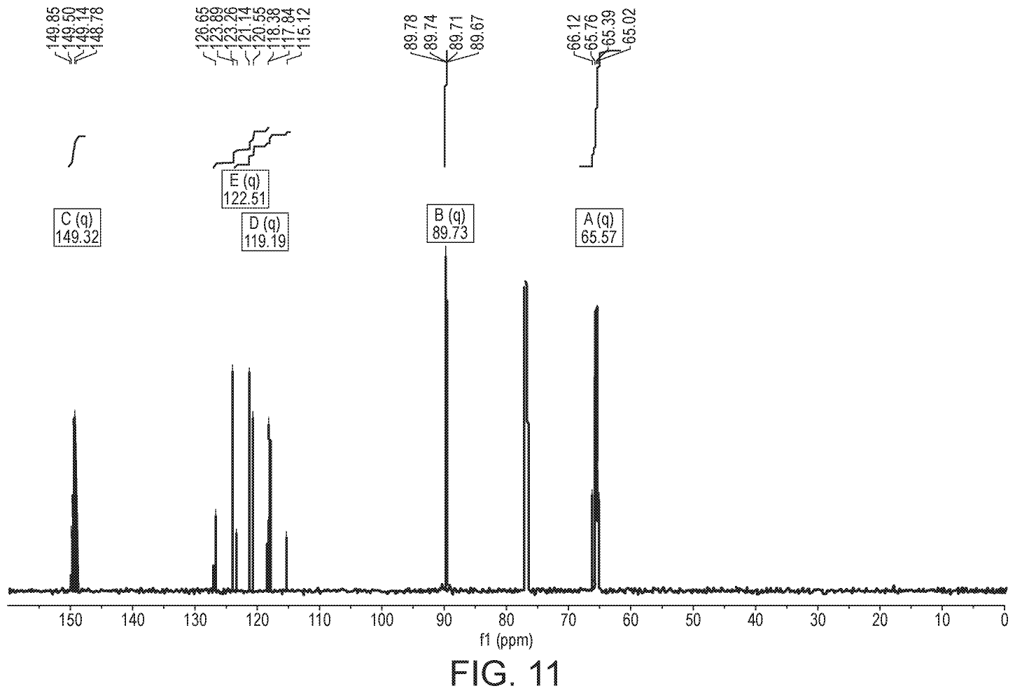

FIGS. 10 and 11 show the NMR Spectral analysis of KDC-704.

¹H NMR (400 MHz, CDCl₃) 5.02 (1H, d, 3JH-H=4.8 Hz, H1 or H2), 4.56 (1H, qd, 3JH-F=4.0 Hz, 3JH-H=2.0 Hz, H1 or H2), 4.16 (2H, q, 3JH-F=7.8 Hz, H3).

¹³C NMR (101 MHz, CDCl₃) 149.32 (q, 2JC-F=36.0 Hz), 122.51 (q, 1JC-F=277.3 Hz), 119.19 (q, 1JC-F=272.7 Hz), 89.73 (q, 3JC-F=3.6 Hz), 65.57 (q, 2JC-F=37.0 Hz).

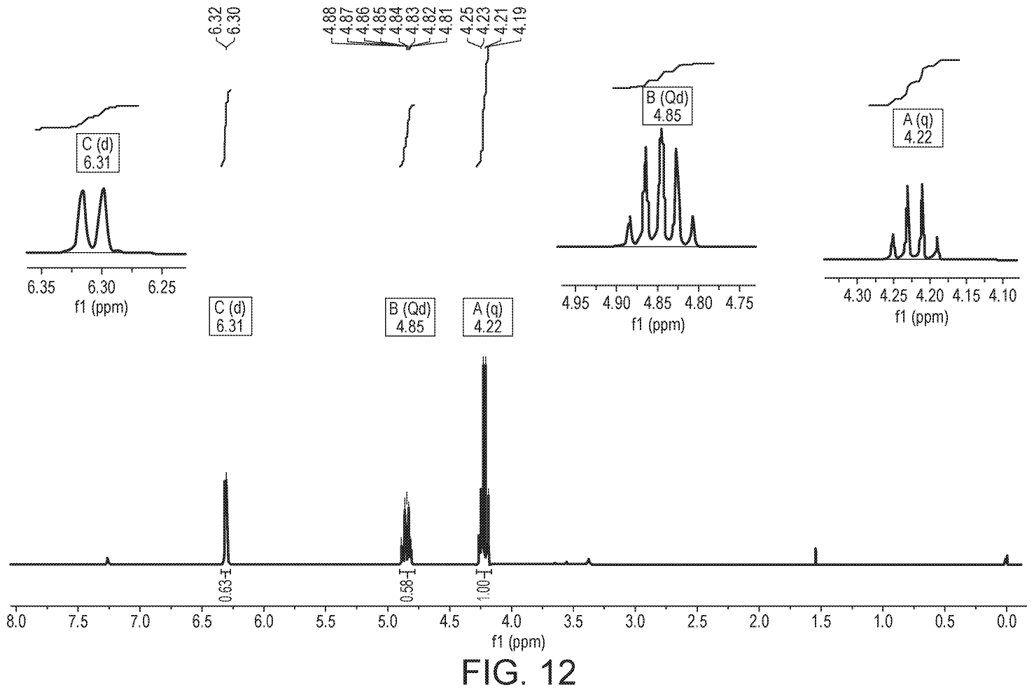

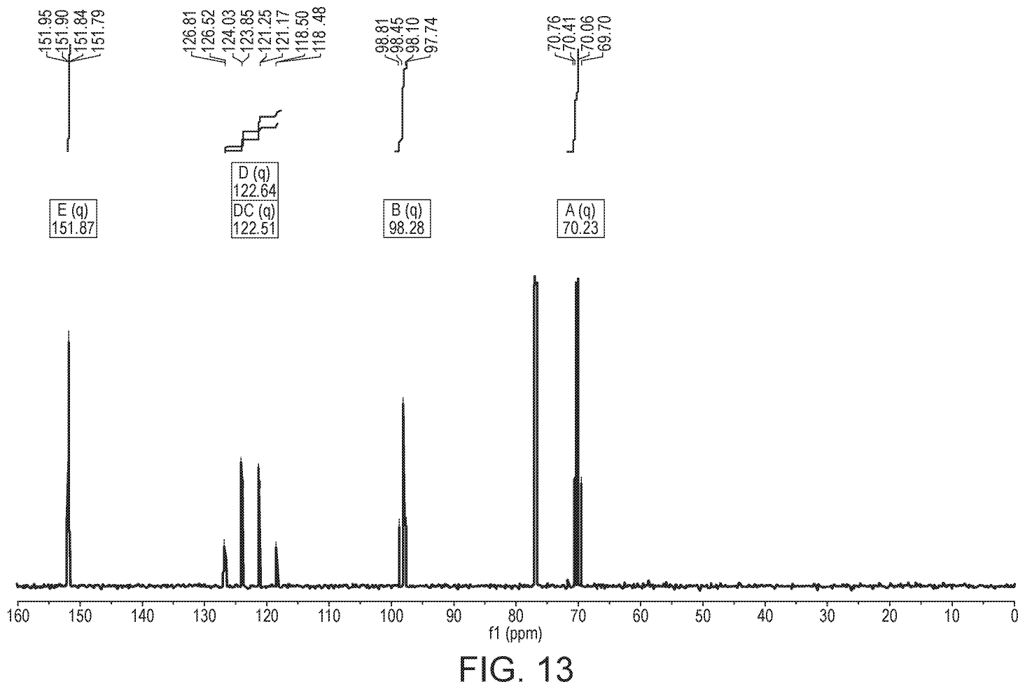

FIGS. 12 and 13 show the NMR Spectral analysis of the Z-isomer of KDC-704.

¹H NMR (400 MHz, CDCl₃) 6.31 (1H, d, 3JH-H=6.9 Hz, H2), 4.85 (1H, qd, 3JH-F=8.0 Hz, 3JH-H=6.9 Hz, H1), 4.22 (2H, q, 3JH-F=8.1 Hz, H3).

¹³C NMR (101 MHz, CDCl₃) 151.87 (q, 3JC-F=5.5 Hz), 122.64 (q, 1JC-F=279.3 Hz), 122.51 (q, 1JC-F=269.2 Hz), 98.28 (q, 2JC-F=35.6 Hz), 70.23 (q, 2JC-F=35.8 Hz).

1. A nonaqueous battery electrolyte formulation, comprising a compound of Formula (1): 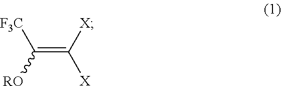
wherein R is selected from the group consisting of a C₁ to C₆ alkyl, alkenyl, or alkynyl group, optionally fully or partially substituted with F, Cl, Br, and/or I;
each X is independently selected from the group consisting of F, Cl, H, CF₃, and C₁ to C₆ alkyl, alkenyl, or alkynyl, which is optionally fully or partially substituted, with F; and
OR is cis- or trans- to any vicinal group.

2. A battery, comprising the battery electrolyte formulation according to claim 1.

3. The formulation according to claim 1, further comprising a metal electrolyte salt, present in an amount of 0.1 to 20 wt % relative to the total mass of the battery electrolyte formulation, and wherein the metal electrolyte salt is a salt of lithium, sodium, magnesium, calcium, lead, zinc, or nickel.

4. (canceled)

5. The formulation according to claim 3, wherein the metal salt is a salt of lithium selected from the group consisting of lithium hexafluorophosphate (LiPF₆), lithium hexafluoroarsenate monohydrate (LiAsF₆), lithium perchlorate (LiClO₄), lithium tetrafluoroborate (LiBF₄), lithium triflate (LiSO₃CF₃), lithium bis(fluorosulfonyl)imide (Li(FSO₂)₂N), and lithium bis(trifluoromethanesulfonyl)imide (Li(CF₃SO₂)₂N).

6. The formulation according to claim 1, further comprising an additional solvent in an amount of from 0.1 wt % to 99.9 wt % of the liquid component of the formulation, wherein the additional solvent is selected from the group consisting of dimethyl carbonate (DMC), ethylmethyl carbonate (EMC), fluoroethylene carbonate (FEC), propylene carbonate (PC), and ethylene carbonate (EC).

7. (canceled)

8. The formulation according to claim 1, wherein in Formula (1), R has the formula C₁₋₆H₀₋₁₃Z₀₋₁₃ (wherein Z is one or more of F, Cl, Br, and/or I.

9. (canceled)

10. A formulation comprising a metal ion and a compound of Formula (2), optionally in combination with a solvent; 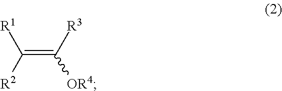
wherein each of R¹, R², R³, and R⁴ is independently selected from the group consisting of a C₁ to C₆ alkyl, alkenyl, or alkynyl group, optionally fully or partially substituted with F, Cl, Br, and/or I;
and
—OR⁴ is cis- or trans- to R¹ or R².

11. A battery comprising the formulation
according to claim 10.

12. The formulation according to claim 10, wherein in Formula (2), each of R¹, R², R³, and R⁴ independently has the formula C₁₋₆H₀₋₁₃Z₀₋₁₃, wherein Z is one or more of F, Cl, Br, and/or I.

13. The formulation according to claim 10, further comprising a metal electrolyte salt, present in an amount of 0.1 to 20 wt % relative to the total mass of the nonaqueous electrolyte formulation, and wherein the metal electrolyte salt is a salt of lithium, sodium, magnesium, calcium, lead, zinc, or nickel.

14. (canceled)

15. The formulation according to claim 13, wherein the metal electrolyte salt is a salt of lithium selected from the group consisting of lithium hexafluorophosphate (LiPF₆), lithium hexafluoroarsenate monohydrate (LiAsF₆), lithium perchlorate (LiClO₄), lithium tetrafluoroborate (LiBF₄), lithium triflate (LiSO₂CF₃), lithium bis(fluorosulfonyl)imide (Li(FSO₂)₂N), and lithium bis(trifluoromethanesulfonyl)imide (Li(CF₃SO₂)₂N).

16. The formulation according to claim 10, further comprising an additional solvent in an amount of from 0.1 wt % to 99.9 wt % of the liquid component of the formulation, wherein the additional solvent is selected from the group consisting of dimethyl carbonate (DMC), ethylmethyl carbonate (EMC), fluoroethylene carbonate (FEC), propylene carbonate (PC), and ethylene carbonate (EC).

17. (canceled)

18. A method of reducing the flammability of a battery and/or a battery electrolyte comprising adding to the battery and/or the battery electrolyte the battery electrolyte formulation according to claim 1.

19. A method of powering an article comprising a battery, the method comprising adding to the battery the battery electrolyte formulation according to claim 1.

20. A method of retrofitting a battery electrolyte comprising either (a) at least partially replacing the battery electrolyte with the battery electrolyte formulation according to claim 1 and/or (b) supplementing the battery electrolyte with the battery electrolyte formulation.

21. A method of preparing a compound of Formula (1) 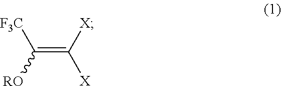
wherein R is selected from the group consisting of a C₁ to C₆ alkyl, alkenyl, or alkynyl group, optionally fully or partially substituted with F, Cl, Br, and/or I;
each X is independently selected from the group consisting of F, Cl, H, CF₃, and C₁ to C₆ alkyl, alkenyl, or alkynyl, which is optionally fully or partially substituted with F; and
—OR⁴ is cis- or trans- to any vicinal group;
the method comprising reacting a compound of Formula (2a) and/or Formula (2b): 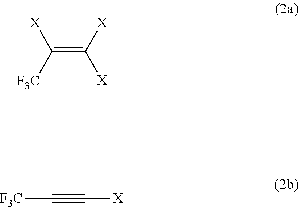
with an alcohol of formula ROH; in the presence of a strong base, optionally in the presence of a solvent, under suitable conditions of temperature and pressure so as to produce the compound of Formula (1).

22. A method of preparing the battery electrolyte formulation according to claim 6 comprising mixing a compound of Formula (1) with the additional solvent and with the salt of lithium so as to produce the formulation.

23. The method according to claim 19, wherein a capacity of the battery and/or charge transfer within the battery is improved relative to a battery without the formulation.

24. The method according to claim 18, wherein the formulation comprises a metal electrolyte salt, present in an amount of 0.1 to 20 wt % relative to the total mass of the nonaqueous electrolyte formulation, and wherein the metal electrolyte salt is a salt of lithium, sodium, magnesium, calcium, lead, zinc, or nickel.

25. (canceled)

26. The method according to claim 24, wherein the metal electrolyte salt is a salt of lithium selected from the group consisting of lithium hexafluorophosphate (LiPF₆), lithium hexafluoroarsenate monohydrate (LiAsF₆), lithium perchlorate (LiClO₄), lithium tetrafluoroborate (LiBF₄), lithium triflate (LiSO₃CF₃), lithium bis(fluorosulfonyl)imide (Li(FSO₂)₂N), and lithium bis(trifluoromethanesulfonyl)imide (Li(CF₃SO₂)₂N).

27. The method according to claim 18, wherein the formulation comprises an additional solvent in an amount of from 0.1 wt % to 99.9 wt % of a liquid component of the formulation, and wherein the additional solvent is selected from the group consisting of dimethyl carbonate (DMC), ethylmethyl carbonate (EMC), fluoroethylene carbonate (FEC), propylene carbonate (PC), and ethylene carbonate (EC).

28. (canceled)

29. The method according to claim 18, wherein in Formula (1), R has the formula C₁₋₆H₀₋₁₃Z₀₋₁₃ (wherein Z is one or more of F, Cl, Br, and/or I.
